(19) United States
(12) Patent Application Publication
(10) Pub. No.: US 2025/0225380 A1
(43) Pub. Date: Jul. 10, 2025

(54) NEUROMORPHIC ISING MACHINE FOR LOW ENERGY SOLUTIONS TO COMBINATORIAL OPTIMIZATION PROBLEMS

(71) Applicants: NTT RESEARCH, INC., SUNNYVALE, CA (US); THE UNIVERSITY OF TOKYO, TOKYO (JP)

(72) Inventors: Timothee Guillaume LELEU, TOKYO (JP); Kazuyuki AIHARA, TOKYO (JP); Yoshihisa YAMAMOTO, SUNNYVALE, CA (US)

(73) Assignees: NTT RESEARCH, INC., SUNNYVALE, CA (US); THE UNIVERSITY OF TOKYO, TOKYO (JP)

(21) Appl. No.: 18/853,925

(22) PCT Filed: Apr. 7, 2023
(86) PCT No.: PCT/US2023/065512

§ 371 Date: Oct. 3, 2024

Related U.S. Application Data
(60) Provisional application No. 63/328,702, filed on Apr. 7, 2022.

(51) Int. Cl. G06N 3/063

(52) U.S. Cl. CPC G06N 3/063

(57) ABSTRACT

In sonic embodiments, an optimization method implemented by a computational subnetwork is provided. The method may include initializing, by a state node of the computational subnetwork, a state vector; injecting, by a context node of the computational subnetwork, amplitude heterogeneity errors to the state vector, the injecting avoiding a solution converging on a local minimum point; and selectively controlling, by an input node of the computational subnetwork, the amplitude heterogeneity error by fixing states of high error states for durations of corresponding refractory periods.

### PRIORITY

This application claims priority to U.S. Provisional Application No. 63/328,702, filed Apr. 7, 2022 and entitled “Neuromorphic Ising Machine For Low Energy Solutions To Combinatorial Optimization Problems,” which has been incorporated by reference in its entirety.

### FIELD

This disclosure relates physical systems-based computing to solve non-deterministic polynomial-time hard (NP-hard) problems such as combinatorial optimization problems. For example, an aspect of the disclosure relates to energy efficient neuromorphic computing systems and methods.

### BACKGROUND

Classical digital computers consume a lot of energy and time to solve NP-hard problems such as combinatorial optimization problems. Special types of physical systems-based computers and devices have been built to overcome these deficiencies of the classical digital computers. A physical system-based computer uses the physical property that the system will ultimately settle (or converge) to a lowest energy state. Therefore, if a combinatorial optimization problem can be mapped to a physical system, the lowest energy state of the physical system corresponds to the solution (i.e., optimal combination) of the problem. Physical systems-based computers have been found to be efficient (e.g., in terms of energy) for solving the combinatorial optimization problems compared to the classical digital computers.

To solve a combinatorial optimization problem, a physical system-based computer starts out with an initial state, which may be a rough estimate of the solution. The initial state may even be randomly selected. An initial cost may be calculated using the initial state on the physical system—with the goal converging to the lowest cost. To iterate towards the lowest cost goal, a gradient descent algorithm may be implemented. The gradient descent algorithm in a given iteration picks the direction of movement that lowers the cost on the next iteration. A minimal point is found when each direction of movement increases the cost.

A regular gradient descent, however, is not sufficient for hard combinatorial optimization problems because they have multiple local minima (i.e., minimal points). Using the regular gradient descent, the solution may therefore get stuck at a local minimum-never reaching the global minimum. To decrease the likelihood of getting stuck at a local minimum, amplitude heterogeneity error terms are introduced. The amplitude heterogeneity error terms are designed to introduce variability (or chaos) in the state, where the variability may prohibit the state from settling to a local minimum. Each iteration of this specialized dynamics that is different from a gradient descent involves a matrix vector multiplication—the vector being the current state and the matrix providing a coupling between the states (in other words, the matrix encoding the combinatorial optimization problem). The matrix vector multiplication is generally dense, further exacerbated by the amplitude heterogeneity error terms. The dense operation is energy intensive, and the computation cost increases as a square of the problem size. For instance, if the problem size is doubled, the computation cost is quadrupled.

Several attempts have been made to reduce energy consumption and/or to realize the solution convergence faster in physical systems-based computers. These attempts, however, have proven to be unsatisfactory. For example, Markov Chain Monte Carlo (MCMC) methods are often used for solving combinatorial problems such as simulated annealing and parallel tempering. These conventional methods often assume detailed balance for the definition of a Markov chain that converges to the Boltzmann distribution and the sampling of lower energy states. However, the strong non-ergodicity of complex systems (e.g., spin glasses, etc.) implies that the system remains trapped within a subspace that is confined near the initial state- and therefore failing to reach the solution.

As another example of unsatisfactory conventional solution, mean-field approximations (e.g., mean field annealing) have recently been implemented on physical hardware such as photonics and memristors. Recent benchmarking has shown that they are likely to solve certain optimization problems faster than MCMC methods. But these systems rely on the gradient descent of Lyapunov function. Because the Lyapunov function is not the same as the target fitness function, these systems are much less likely to reach the solution. Mean-field approximations methods have been augmented by including auxiliary feedback error correction in an attempt to improve convergence speed to the minimum (or approximate minimum) of the fitness function. By controlling entropy production, the augmented methods have found solutions of optimization problems orders of magnitude faster than simple mean-field approximations and MCMC methods. But their implementation often requires calculating matrix-vector multiplications for each step of the calculations for which the computational complexity scales as the square of the problem size. Consequently, the computational requirement (time and energy) becomes significantly higher for very large problem sizes, which therefore limits the applicability of such methods to solve real-world problems.

Moreover, the amount of information contained in the vector, which represents the state communicated between the different parts of the system, is large because it represents analog variables.

Lastly, conventional solutions utilize amplitude heterogeneity error for a limited set of problems such as binary optimization problems which limits the generalization of the approach to other problems such as integer programming.

As such, a significant improvement on the physical systems-based computers is therefore desired, particularly to lower energy usage and computation cost.

### SUMMARY

In some embodiments, an optimization method implemented by a computational subnetwork is provided. The method may include initializing, by a state node of the computational subnetwork, a state vector; injecting, by a context node of the computational subnetwork, amplitude heterogeneity errors to the state vector, the injecting avoiding a solution converging on a local minimum point; and selectively controlling, by an input node of the computational subnetwork, the amplitude heterogeneity error by fixing states of high error states for durations of corresponding refractory periods.

In some embodiments, a system is provided. The system may include a plurality of computational subnetworks, configured to perform an optimization method, each computational subnetwork comprising: a state node configured to store a state element of a current state vector; a context node configured to introduce an amplitude heterogeneity error to the state element stored in the state node; and an input node configured to control the amplitude heterogeneity error of the state element by fixing the state of the state element for a corresponding refractory period.

### BRIEF DESCRIPTION OF DRAWINGS

FIG. 1 shows an illustrative computational core, according to example embodiments of this disclosure.

FIG. 2 shows a detailed view of an illustrative computational core, according to example embodiments of this disclosure.

FIG. 3 shows an illustrative microstructure within a subnetwork. according to example embodiments of this disclosure.

FIG. 4 shows illustrative microstructures, according to example embodiments of this disclosure.

FIG. 5 shows a flow diagram of an illustrative method of solving a given problem, according to example embodiments of this disclosure.

FIG. 6 shows a flow diagram of an illustrative method of determining hyperparameters for solving a combinatorial optimization problem, according to example embodiments of this disclosure.

FIG. 7 shows example graphs illustrating a reduction of energy consumption by correcting amplitude heterogeneity, according to example embodiments of this disclosure.

FIG. 8 shows examples graphs illustrating the beneficial effects of controlling flipping fluctuations, according to example embodiments of this disclosure.

FIG. 9 shows an example graph illustrating flips to solution convergence, according to example embodiments of this disclosure.

FIG. 10A shows a flow diagram of an example method for block sparsifying state vectors, according to example embodiments of this disclosure.

FIG. 10B shows an example state matrix and an example block sparse condensed state matrix, according to example embodiments of this disclosure.

FIG. 11 shows a graph illustrating speed gain in solution convergence due to block sparsification, according to example embodiments of this disclosure.

FIG. 12 shows an example system illustrating graphics processing unit (GPU) based hardware implementation of example embodiments of this disclosure.

FIG. 13 shows an example system illustrating field programmable gate array (FPGA) based hardware implementation of example embodiments of this disclosure.

FIG. 14 shows an example system illustrating application specific integrated circuit (ASIC) chiplet neuromorphic hardware implementation of example embodiments of this disclosure.

FIG. 15 shows an example system illustrating hybrid digital electronic hardware and non-volatile memory-based implementation of example embodiments of this disclosure.

FIG. 16 shows an example system illustrating hybrid digital electronic hardware and photonics on chip implementation of example embodiments of this disclosure.

FIG. 17 shows an example system illustrating hybrid digital electronic hardware and an optical domain spatial matrix-vector multiplier of example embodiments of this disclosure

The figures are for purposes of illustrating example embodiments, but it is understood that the present disclosure is not limited to the arrangements and instrumentality shown in the drawings. In the figures, identical reference numbers identify at least generally similar elements.

### DESCRIPTION

Embodiments described herein solve the aforementioned problems and may provide other solutions as well. State vector amplitude heterogeneity, introduced to decrease the likelihood of a solution to combinatorial optimization problem converging on a local minimum, is controlled by introducing a proportional error correction. For instance, for a particular state element (e.g., spin) of the state vector, a refractory period is selected based on the variability introduced to the state element by the amplitude heterogeneity—where, in the refractory period, the changes in the state of the state element are ignored (or the state of the state element is fixed). In other words, the state vector is sparsified—because there are no changes to track for the state elements with a higher variability (e.g., high spin flipping rates). Such sparsification lowers the number of computations because the corresponding state elements can be safely ignored for a given computation (e.g., matrix-vector multiplication). Furthermore, the sparsification decreases the memory load because the corresponding weights—as they are not used for the given computation—do not have to be accessed from memory. The state communicated between the different parts of the system is also quantified, i.e., the amount of information (such as bits in digital electronics) is rendered minimal which results in the reduction of the calculation cost and contributes to the reduction of the memory bottleneck. The quantified information exchanged between the different part of the system can also be subject to probabilistic variations without affecting the dynamics of the system which improves the robustness in the case of an implementation on hardware that is subject to unavoidable fluctuations.

Embodiments disclosed herein also describe neuromorphic data processing device for solving optimization problems including Ising (quadratic unconstrained binary optimization), linear/quadratic integer programming, and/or satisfiability problems-while consuming low energy. The systems and methods disclosed herein can find optimal combinations for complex combinatorial problems considerably faster and at lower energy cost than other existing algorithms and hardware. The computational paradigm is generally based on leveraging properties of statistical physics, computational neuroscience, and machine learning. First, non-equilibrium thermodynamics of a system that does not exhibit detailed balance is leveraged to find the lower energy state of a fitness function. The dynamics of the system is designed using analog and discrete states that are analogous to event-based communication, called spikes in biological neural processing. Furthermore, the concept of neural sampling is further extended beyond the notion of equilibration to the Boltzmann distribution and to include the case where the duration of the refractory period is dynamically modulated for each spin based on the detection of the susceptibility of global convergence to a particular spin flip. Third, the system is modulated by a semi-supervised machine learning for autonomously generating training data and shaping the structure of the model and/or finding optimal hyperparameters by a combination of Bayesian optimization and graph neural networks.

For a given computation (e.g., matrix vector multiplication), top-down auxiliary signals keep a trace of past activity at a slower time scale for building prior knowledge about the solution of a combinatorial optimization problem. The top-down auxiliary signals are further used to destabilize local minima by a controlled production of entropy—i.e., through an introduction of amplitude heterogeneity. Bottom-up auxiliary signals are used to control the statistical properties of events used for information exchange within the system, such as reducing the variance of state changes caused by the introduction of the amplitude heterogeneity and number of flipping events. Such controlled reduction in variance (or a controlled reduction of entropy) limits the memory output bottleneck (because weights associated with state elements with high variance are not retrieved for computation during a refractory period) and further reduces computational time and energy consumption.

One having ordinary skill in the art will recognize that the embodiments may provide improvements over the conventional mean-field approximations, which require computational resources that scale as the square of the problem size. Because of the bottom-up auxiliary signals (also referred to as auxiliary error corrections), each step has a lower cost calculation—as the bottom-up auxiliary signals effectively sparsify the state vector. Additionally, because not all elements of the state vectors are used for the calculation, the slow-access memory bottleneck is significantly reduced. Furthermore, embodiments disclosed herein are also applicable to solve general types of combinatorial optimization problems such as quadratic integer programming. Additionally, the systems disclosed herein are able to adapt to new problems by learning from previously seen examples.

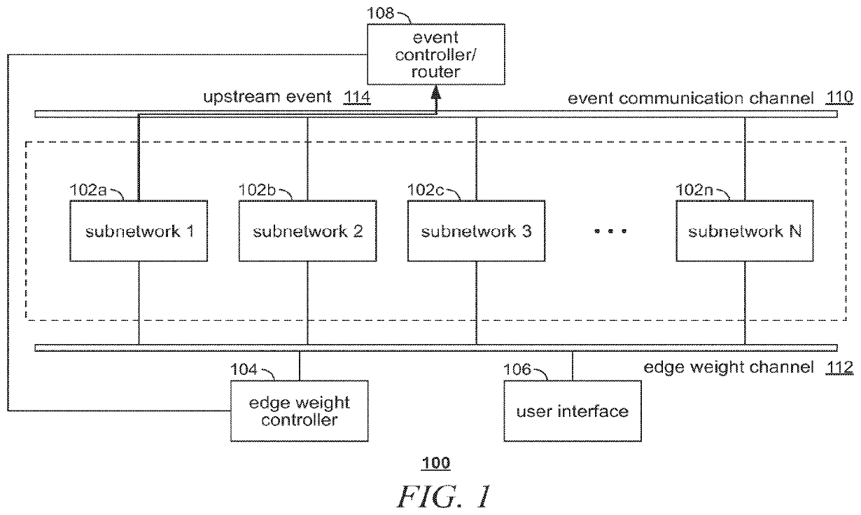

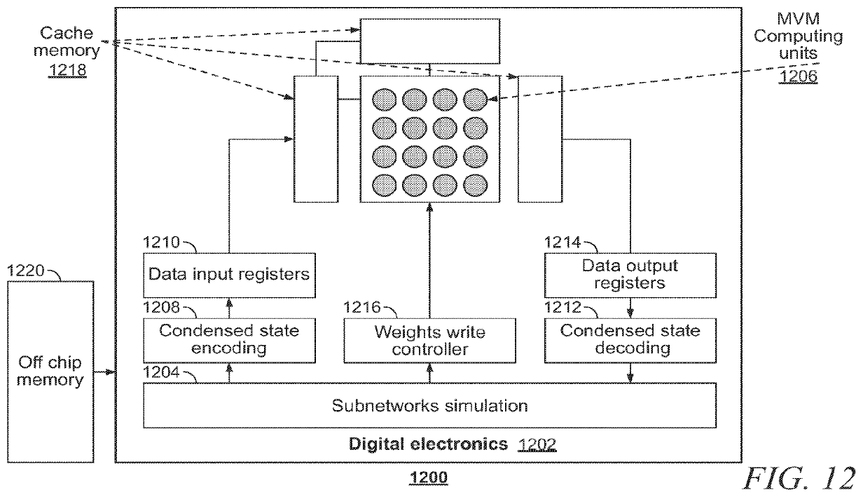

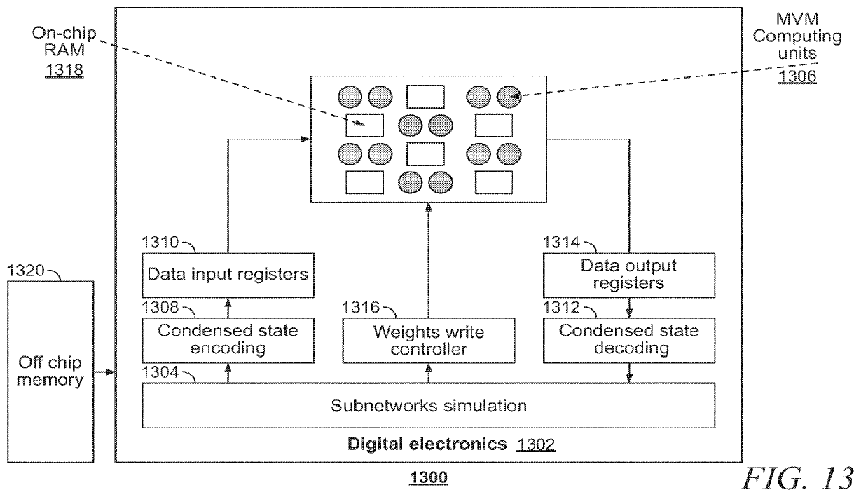

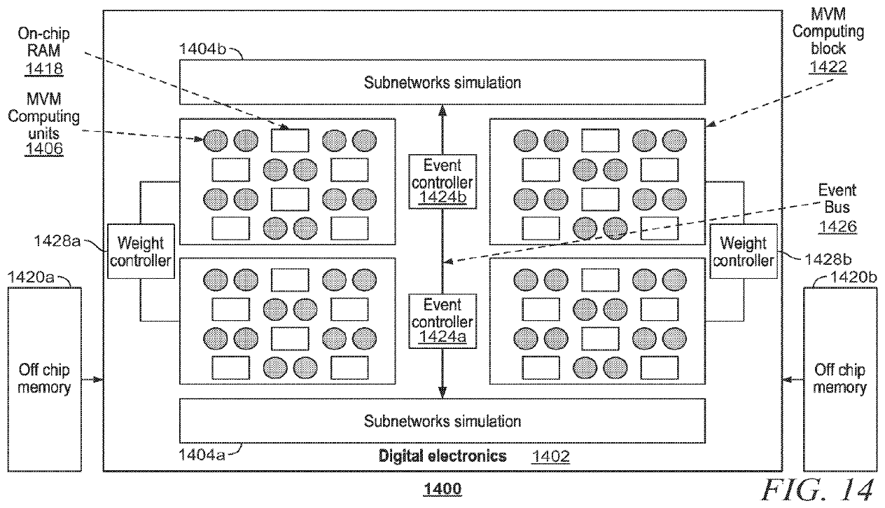

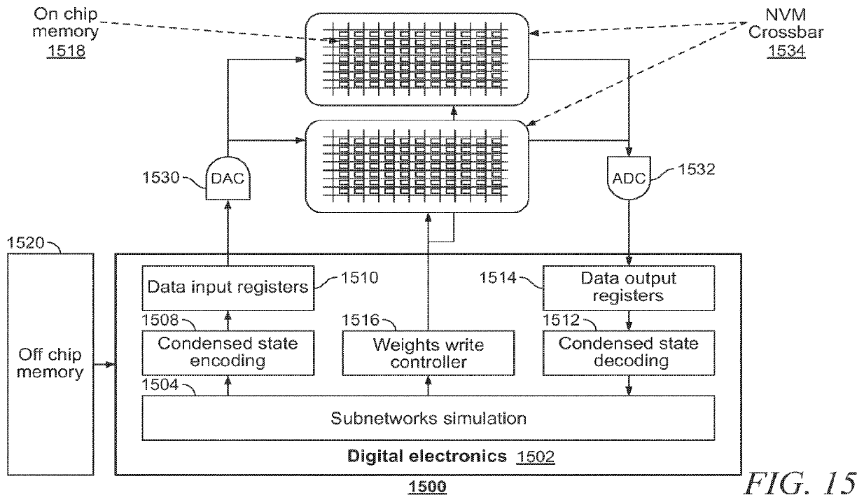

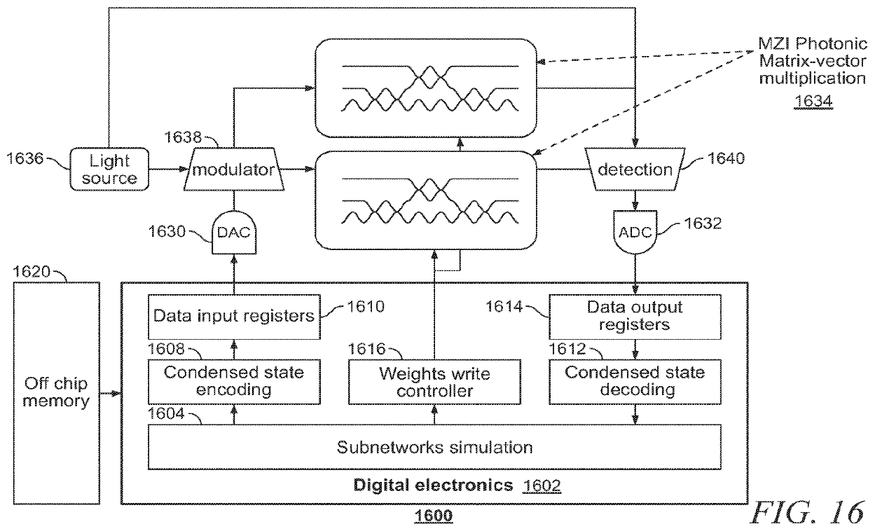

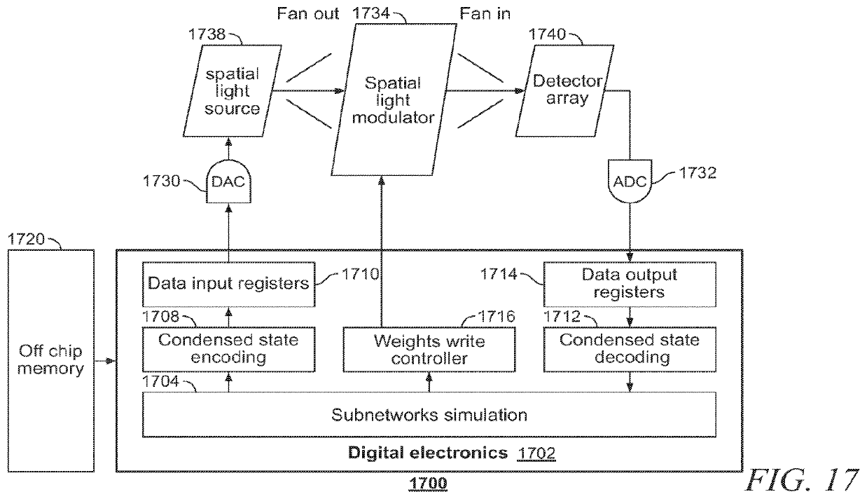

FIG. 1 shows an illustrative computational core 100, according to example embodiments of this disclosure. The computational core 100 may form a smaller computing portion (e.g., a piece of hardware) in a larger computing system. For instance, the computational core 100 may form a small part of a larger processor. As described herein, the computational core 100 may be implemented in a graphics processing unit (GPU) based hardware as shown in FIG. 12, field programmable gate array (FPGA) based hard hardware as shown in FIG. 13, application specific integrated circuit (ASIC) based hardware as shown in FIG. 14, hybrid digital electronic hardware and non-volatile memory as shown in FIG. 15, hybrid digital electronic hardware and photonics and chip as shown in FIG. 16, and hybrid digital electronic hardware and an optical domain spatial matrix-vector multiplier as shown in FIG. 17. It should be understood that these implementations are just examples and should not be considered limiting. For example, the computational core 100 may be implemented in an all-optical computing system. As shown, the computational core 100 may comprise N subnetworks 102a-102n (collectively referred to as subnetworks 102 and commonly referred to as a subnetwork 102), an event communication channel 110, an event controller (also referred to as a router) 108, edge weight channel 112, an edge weight controller 103, and a user interface 106. It should however be understood that the components of the computational core 100 are merely examples and computational cores with additional, alternative, or fewer number of components should be considered within the scope of this disclosure. The computational core 100 is generally configured to perform neuromorphic computations, with different portions (e.g., nodes) transmitting and receives neuromorphic events (e.g., spikes) as detailed below. In some embodiments, spin information for each subnetwork 102 may be encoded in a single transistor operating in a subthreshold region. The computational core 100 is sometimes referred to as a data processing unit.

The N subnetworks 102 may be utilized for a combinatorial optimization problem with N variables. As shown, the N subnetworks 102 may be coupled with each other, with event-based communication protocol (e.g., by using the event communication channel 110). For instance, if there is spin (an example of a state element) flip in one subnetwork 102, i.e., a bit changes from “0” to “1” or vice versa, the event is sent to all the other subnetworks 102 (e.g., a spike is sent to all the other subnetworks 102). Particularly, when the event controller 108 detects a change in state (e.g., flipping of the spin) in any of the subnetworks 102, the event controller 108 may propagate the detection of this event to all the other subnetworks 102 through the event communication channel 110. The events (i.e., representing change of state) are augmented using weights (e.g., representing the problem to be solved) propagated through the edge weight channel 112. For example, the edge weight controller 104 controls which weights are to be output from memory (and propagated through the edge weight channel 112) for a given iteration. Because only a subset of the weights is output from memory, this reduces the memory bottleneck (the memory bottleneck is generally caused by the inherent slowness of memory operations). For example, if a state element is within a refractory period, the corresponding weight is not needed for a corresponding iteration. Therefore, its weight may just be kept in the memory, thereby reducing the amount of information exchange with the memory.

In addition to using the sparsity of the vector, sparsity of the problem may also be used to reduce the energy usage. For example, the problem may not be densely connected, and the event controller 108 may not have to propagate a change in one subnetwork 102 to all the other subnetworks 102. The propagation may just be from a subnetwork 102 to the corresponding sparsely connected subnetworks 102.

In some embodiments, local subnetworks 102 may have direct communication paths without going through the event communication channel 110. For example, subnetworks 102a-120c form a local communication patch and the communications within it are direct and not controlled by the event controller. However, if subnetworks 102a-102c within this local communication patch have to communicate with other remote subnetworks (e.g., subnetwork 102n), such communication is facilitated by the event controller 108 using the event communication channel 108.

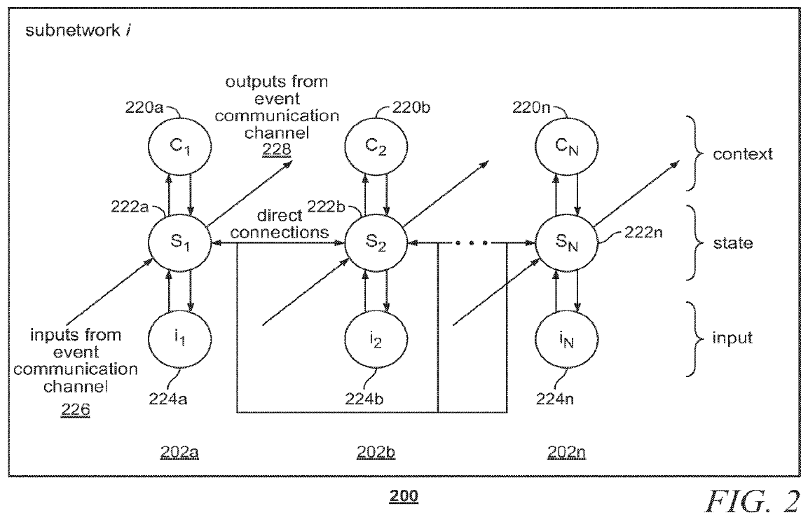

FIG. 2 shows a detailed view of an illustrative computational core 200, according to example embodiments of this disclosure. The computational core 200 may be similar to the computational core 100 shown in FIG. 1. As shown, the computational core 200 comprises subnetworks 202a-202n (collectively referred to as subnetworks 202 and commonly referred to as subnetwork 202). In other words, each column may represent a subnetwork 202. The subnetworks 202a-202n comprise corresponding three layers of nodes: state nodes 222a-220n (collectively referred to as state nodes 222 and commonly known as state node 222), input nodes 224a-224n (collectively referred to as input nodes 224 and commonly referred to as input node 224), and context nodes 220a-220n (collectively referred as context nodes 220 and commonly referred as context node 220). The input nodes 224 send excitatory inputs to corresponding state nodes 222. State nodes 222 encode using (quantum) analog variables for the current configuration of the combinatorial problem. The current configuration is based on inputs 226 received from the event communication channel. The state nodes 222 further outputs 228 to the event communication channel. In some embodiments, the state nodes 222 may represent a binary variable, which should not be considered limiting. For instance, the state nodes 222 may represent multi-level variables such as integers.

The context nodes 220 provide corresponding amplitude heterogeneity error terms (or simply referred to as amplitude heterogeneity) to the state nodes 222. The amplitude heterogeneity error terms may represent a top-down control of the corresponding state nodes 222 to introduce more variability (e.g., increase the number of flips). The variability may decrease the likelihood that the solution converges to a local minimum. The input nodes 224 may provide an error correction to the state nodes 222 to counterbalance or reduce the variability introduced by the corresponding context nodes 220. Therefore, the input nodes 224 may temper some of the chaos (or entropy) generated in state nodes 222 by the corresponding context nodes 220. In other words, the input nodes 224 may introduce sparsity into the state vector or state vector change in time (as represented by the state nodes 222), by ignoring the state elements that do not contribute significantly to the dynamics of global convergence. More specifically, the input nodes 224 may impose a refractory period proportion to a signal that detects the importance of each spin flip by the context nodes 220. One of such signals can be the high variance introduced by the context node 220 or state node 222. Another example of such a signal is the strength of the internal field equal to the result of the matrix-vector multiplication between the problem-specific weights and the vector of state nodes 222. During the refractory period the spin of the corresponding state node 222 is fixed and changes to its states are not tracked. The duration of the refractory period is different for each state node 222 and is modulated by its corresponding input node 224. In other words, the input nodes 224 control the flipping fluctuations introduced by the context nodes 222 to the state nodes 222. The control of flipping fluctuations is mathematically described below.

The control of flipping fluctuations can be added to any of the models proposed herein. The error signal vᵢ may increase and decrease when the spin sᵢ flips more and less frequently than the other spins, respectively. vᵢ can be described as follows:

$${v}_{i} ( t + 1 ) = {v}_{i} ( t ) + [ κ ( {f}_{i} ( t ) - {f}^{*} ) {v}_{i} ( t ) ] dt$$

Alternatively, the variables vᵢ can be described as follows:

$${v}_{i} ( t + 1 ) = {v}_{i} ( t ) + [ - ( {f}_{i} - {f}^{*} ) - κ {v}_{i} ( t ) ] dt$$

where, in both of the above equations, fᵢ may be signal detecting if a flip of spin i significantly affects the dynamics of convergence to the global minimum or an approximation of it. Moreover, f* is the target signal defined to fix the sparsity of spin flips to a certain target value. The signal fdᵢ can either be the spin flip |sᵢ(t)−sᵢ(t−1)|, the variance |xᵢ(t)−xᵢ(t−1)|, the internal field hᵢ=Σᵢⱼωᵢⱼ, or directly the error signal eᵢ. The target signal f* can either be equal to fixed annealing function g(t) or can be proportional to the average <fᵢ>g(t). vᵢ(t) is normalized in the interval [0,1]. Next, vᵢ(t) may be used to impose “refractory” periods for the flip sᵢ(t). Embodiments disclosed herein describe two possible methods to improve the refractory period. In a first method, s,(t) may be prevented to flip with the probability 1−vᵢ(t). In a second method, the neuron vᵢ(t) cannot flip for a duration proportional to vᵢ(t) (called refractory period).

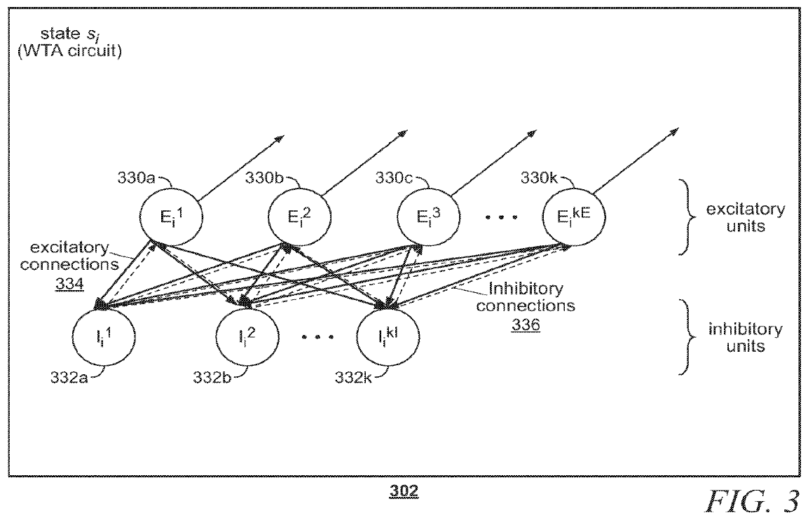

FIG. 3 shows an illustrative microstructure within a subnetwork 302 (similar to subnetworks 102 shown in FIG. 1 and/or similar subnetworks 202 shown in FIG. 2), according to example embodiments of this disclosure. As shown, the microstructure in the subnetwork 302 may include a plurality of excitatory units 330a-330k (collectively referred to as excitatory units 330 and commonly referred to excitatory unit 330) and a plurality of inhibitory units 332a-332k (collectively referred to as inhibitory units 332 and commonly referred to inhibitory unit 332). The connections from the excitatory units 330 to the inhibitory units 332 are referred to as excitatory connections 334 and connections from the inhibitory units 332 to the excitatory units 330 are referred to as inhibitory connections 336. The interconnections between the excitatory units 330 and inhibitory units 332 are based on Dale's principle as understood in the art. Furthermore, the excitatory units 330 and the inhibitory units 332 form a bipartite network, meaning that there are no connections between the excitatory units 330 and excitatory units 3320 and that there are no connections between the inhibitory units 332 and inhibitory units 332. In some instances, connections between the excitatory units can be considered without loss of functionality.

The microstructure with multiple excitatory units 330 and inhibitory units 332 makes the subnetwork 302 generalizable and not just confined to holding and changing binary spin information. For example, the microstructure may allow the subnetwork 302 to hold and change integer values or any other type of multi-level variable values. For instance, multi-level variable may be binary encoded with different nodes representing different bits of the binary code. As another example, a polling protocol may be applied to determine which one of the nodes is active and using the position of the active node to determine the value of the multi-level variable (e.g., a third node being active may represent an integer 3). These encodings are just some examples and any kind of encoding may be applied to represent a multi-level variable using a winner takes all circuits.

The microstructure may be described using multiple mathematical models, including but not limited to: mean-field winner-take-all with error correction, Boltzmann machine with error correction, probabilistic winner-take-all Boltzmann with error correction, or spiking chaotic amplitude control. Each of these mathematical models is described below.

### Mean-Field Winner-Take-all Error Correction.

The change in x-dimension, y-dimension, and the error correction e can be represented by the following differential equations:

$$\frac{{dx}_{i}}{dt} = - μ {x}_{i} + {f}_{i}^{+} - {f}_{i}^{-} ,$$

$$\frac{{dy}_{i}}{dt} = - μ {y}_{i} + {f}_{i}^{+} + {f}_{i}^{-} ,$$

$$\frac{{de}_{i}}{dt} = - ξ ( {x}_{i}^{2} - a ) {e}_{i} ,$$

where xᵢ and yᵢ may be the two quadrature components of the signal, eᵢ may be an exponentially varying error signal, and a may the target intensity, fᵢ⁺ and fᵢ⁻ may be sigmoid functions defined below.

$${μ}_{i} = {e}_{i} \frac{ϵ}{2} {\sum }_{j} {ω}_{ij} {x}_{i}$$

$${v}_{i} = {e}_{i} \frac{ϵ}{2} {\sum }_{j} \vert {ω}_{ij} \vert {y}_{i}$$

where μᵢ and vᵢ may be the two coupling terms from a node j to node i, the individual weights in the couplings may be given by ωᵢⱼ, and ϵ may be a parameter value (e.g., a constant predetermined parameter).

$${u}_{i} = ϕ ( {α}_{EL} {u}_{i} - {θ}_{I} ) , {f}_{i}^{+} = ϕ ( {v}_{i} + {μ}_{i} - {u}_{i} - {θ}_{E} + \frac{α}{2} ( {y}_{i} + {x}_{i} ) ) ,$$

$${f}_{i}^{-} = ϕ ( {v}_{i} - {μ}_{i} - {u}_{i} - {θ}_{E} + \frac{α}{2} ( {y}_{i} - {x}_{i} ) ) .$$

where ϕ may be a nonlinear filter function (e.g., a sigmoid function), θ_{E} may be a temperature parameter, and α may be a constant predetermined parameter.

### Mean-field Boltzmann Machine.

Continuing with the above symbols, a mean-field Boltzmann machine can be represented as:

$$\frac{{du}_{i}}{dt} = - α {u}_{i} + {μ}_{i}$$

$${μ}_{i} = {\sum }_{j} {ω}_{ij} {s}_{i}$$

$${x}_{i} = ϕ ( - ϵ {u}_{i} )$$

$$ϕ ( x ) = \frac{1}{1 + {e}^{- x}}$$

Mean-Field Boltzmann Machine with Error Correction.

The above model may be modified by introducing the error correction term e as follows:

$$\frac{{du}_{i}}{dt} = - α {u}_{i} + {μ}_{i}$$

$$\frac{{de}_{i}}{dt} = - ξ ( {x}_{i}^{2} - a ) {e}_{i}$$

$${μ}_{i} = {\sum }_{j} {ω}_{ij} {x}_{i}$$

$${x}_{i} = ϕ ( - β {e}_{i} {u}_{i} )$$

$$ϕ ( x ) = \frac{1}{1 + {e}^{- x}}$$

where ξ and β may be constant parameters that may control the rate of the error signal eᵢ.
Boltzmann Machine with Error Correction.

Similarly, an error correction term e can be introduced to the Boltzmann machine model as follows:

$$\frac{{du}_{i}}{dt} = - α {u}_{i} + {μ}_{i}$$

$$\frac{{de}_{i}}{dt} = - ξ ( {x}_{i}^{2} - a ) {e}_{i}$$

$${μ}_{i} = {\sum }_{j} {ω}_{ij} {s}_{i} ( t ) + {b}_{i}$$

$$P ( {s}_{i} ( t ) = 1 ) = {x}_{i} ( t )$$

$$P ( {s}_{i} ( t ) = - 1 ) = 1 - {x}_{i} ( t )$$

$${x}_{i} = ϕ ( - β {e}_{i} {u}_{i} )$$

$$ϕ ( x ) = \frac{1}{1 + {e}^{- x}}$$

where bᵢ may be an output to other nodes.

Winner Takes All Boltzmann Machine With Error Correction. Continuing with using the symbols above, a winner takes all Boltzmann Machine with error correction can be represented with the following steps:
Step 0: External Reset using two input signals:

$${\tilde{y}}_{i}^{\pm } ( t , 2 ) = {y}_{i}^{\pm } ( t , 2 ) ( 1 - {δ}_{i} ( t ) )$$

$${\tilde{z}}_{i}^{\pm } ( t , 2 ) = {z}_{i}^{\pm } ( t , 2 ) ( 1 - {δ}_{i} ( t ) ) ,$$

where δᵢ(t)=1 with probability v₀
Step 1: Recurrent Inputs:

$${μ}_{i}^{\pm } ( t + 1 , 1 ) = {\tilde{e}}_{i}^{\pm } {\sum }_{j} {ω}_{ij}^{\pm } {\tilde{y}}_{j}^{+} ( t , 2 )$$

Step 2: Excitatory Neurons Fire:

$$P ( {y}_{i}^{\pm } ( t + 1 , 2 ) = 1 ) = ϕ ( {u}_{i}^{\pm } ( t + 1 , 2 ) )$$

$$( {u}_{i}^{\pm } ( t + 1 , 2 ) ) = {μ}_{0} ( t + 1 , 1 ) {w}_{in} + {\tilde{y}}_{i}^{\pm } ( t , 2 ) {w}_{self} + {\sum }_{k} {w}_{inh} {\tilde{z}}_{i}^{k} ( t , 3 ) - {b}_{out} + {μ}_{i}^{\pm } ( t + 1 , 1 )$$

where wᵢₙ may be the weight of excitatory signal received by the neuron, wᵢₙₕ may the weight of an inhibitory signal received by the neuron, and w_{self} may be weight of self-coupling.
Step 3: Inhibitory Neurons Fire:

$$P ( {z}_{i}^{k} ( t + 1 , 3 ) = 1 ) = ϕ ( {v}_{i}^{k} ( t + 1 , 3 ) )$$

$${v}_{i}^{k} ( t + 1 , 3 ) = ( {\tilde{y}}_{i}^{+} ( t + 1 , 2 ) + {\tilde{y}}_{i}^{-} ( t + 1 , 2 ) ) {w}_{out} - {b}_{inh}$$

### Spiking Chaotic Amplitude Control:

Continuing with the symbols from above, spiking chaotic amplitude control may be modeled as:

$${x}_{i} ( t + 1 ) = {x}_{i} ( t ) + [ ( - 1 + p ) {x}_{i} - β {e}_{i} {\sum }_{j} {ω}_{ij} {r}_{j} + h 〈 {r}_{j} 〉 ] dt$$

$${e}_{i} ( t + 1 ) = {e}_{i} ( t ) - ξ ( {x}_{i}^{2} - a ) dt$$

$${z}_{i} ( t + 1 ) = \{ \begin{matrix}{z}_{i} ( t ) + \vert {x}_{i} ( t ) \vert & if {z}_{i} ( t ) + \vert {x}_{i} ( t ) \vert < 1 \\ {z}_{i} ( t ) - 1 & otherwise\end{matrix}$$

$${r}_{i} ( t ) = \{ \begin{matrix}sign ( {x}_{i} ) & if {z}_{i} ( t ) + \vert {x}_{i} ( t ) \vert < 1 \\ 0 & otherwise\end{matrix}$$

where h may be a predefined constant parameter.

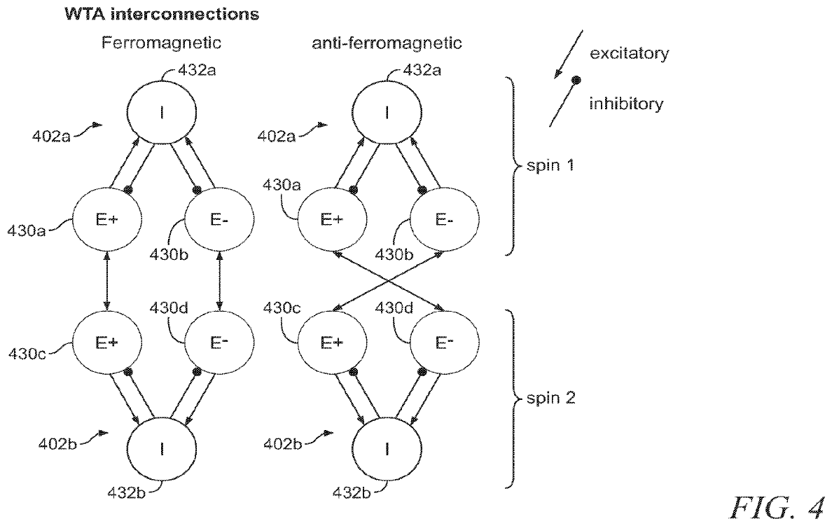

FIG. 4 shows illustrative microstructures 402a and 402b (similar to microstructure 302 shown in FIG. 3), according to example embodiments of this disclosure. As shown, the first microstructure 402a may correspond to a first spin and the second microstructure 402b may correspond to a second spin. The connection between the first microstructure 402a and the second microstructure 402b is ferromagnetic (for the spins of the microstructures to align) or anti-ferromagnetic (for the spins the microstructures to oppositely align). Each of the microstructures 402a and 402d comprise excitatory nodes, inhibitory nodes, excitatory connections, and inhibitory connections. As shown, the first microstructure 402a has excitatory nodes 430a and 430b and an inhibitory node 432a and the second microstructure 402b has excitatory nodes 430c and 430d and an inhibitory node 432b.

The microstructures 402a and 402b may be structured as winner takes all circuits. A winner takes all circuit is configured such that out of k excitatory nodes and l inhibitory nodes, only one excitatory node will win (be active) after the circuit has iterated through a few cycles. More particularly, of the two excitatory nodes 430a-430b within the first microstructure 402a, only one node will remain active after a few iterations. Similarly, of the two excitatory nodes 430c-430d with the second microstructure 402b, only one node will remain active after a few iterations. The mathematical models of the winner take all circuits are described above.

The net result of winner takes all structure for the first microstructure 402a is that only one of the excitatory nodes 430a (e.g., indicating a spin “1”) and 430b (e.g., indicating spin “0”) remains active. The active excitatory node (i.e., either of 430a and 430b) drives the second microstructure 402b to align with the first microstructure 402a in the ferromagnetic orientation (a positive coupling between spins 1 and 2) and drives the second microstructure 402b to oppositely align (a negative coupling between the spins 1 and 2) with the first microstructure 402a in the anti-ferromagnetic orientation.

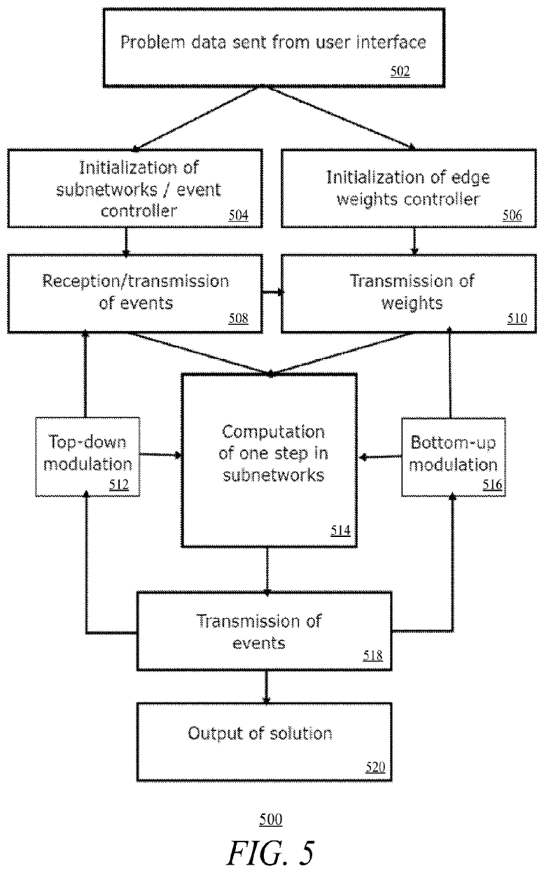

FIG. 5 shows a flow diagram of an illustrative method 500 of solving a given problem, according to some embodiments of this disclosure. It should however be understood that the steps shown in FIG. 5 and described herein are merely examples and should not be considered limiting. That is, methods with additional, alternative, or fewer number of steps should be considered within the scope of this disclosure. It should further be understood that there is no requirement that the steps are to be followed in the order they are shown. One or more steps of the method 500 may be performed by the computational core 100 (e.g., various components of the computational core 100) shown in FIG. 1.

The method 500 may begin at step 502 where a user interface (e.g., user interface 106 shown in FIG. 1) may send problem data to subnetworks (e.g., subnetworks 102 shown in FIG. 1) and edge weight controller (e.g., edge weight controller 104 shown in FIG. 1). In other words, the problem data is mapped to the hardware (e.g., of the computational core 100 shown in FIG. 1). At step 504, the subnetworks/event controller are initialized—i.e., the initial state of the system is initialized. At step 506, the edge weight controllers are initialized. At step 508, events in the subnetworks are received and step 510 the weights (representing the problem to be solved) corresponding to the events are transmitted. Based on the events (generated/received at step 508) and weights (transmitted/received at step 510), the subnetworks may perform computation of one step at step 514.

At steps 518, the events based on the computations are transmitted to the subnetworks. At step 512, a top-down modulation (to introduce amplitude heterogeneity error term) is feedback to the computation step 514. At step 516, a bottom-up modulation (to reduce the amplitude heterogeneity error terms) is feedback to the computation step 514. The cycles of steps 508, 510, 514, 512, 516, and 518 may be performed iteratively until a solution is found (i.e., when convergence is reached). Once the solution is reached, it is outputted at step 520. Particularly, the bottom-up modulation may sparsify the state vector for each computation state 514, based on the embodiments disclosed herein—thereby reducing computation costs.

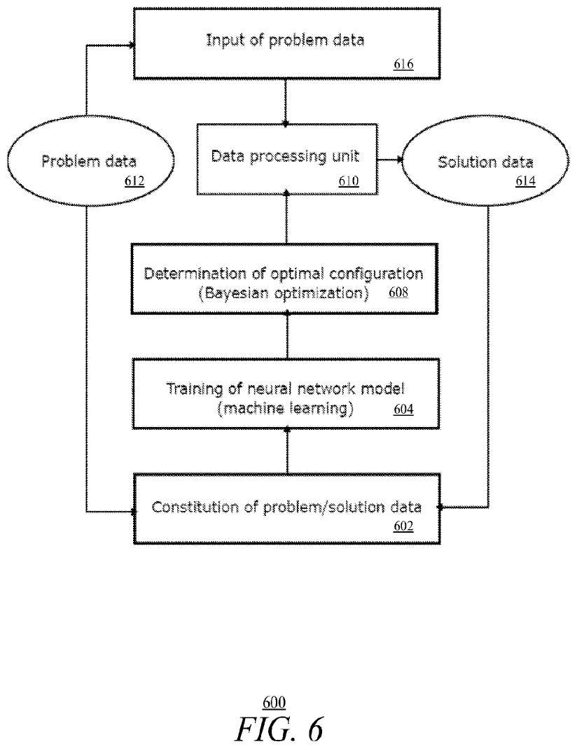

FIG. 6 shows a flow diagram of an illustrative method 600 of determining hyperparameters (and/or any other types of variables) for solving a combinatorial optimization problem, according to example embodiments of this disclosure. It should however be understood that the steps shown in FIG. 6 and described herein are merely examples and should not be considered limiting. That is, methods with additional, alternative, or fewer number of steps should be considered within the scope of this disclosure. It should further be understood that there is no requirement that the steps are to be followed in the order they are shown. The method 600 may be based on maintaining a library of problem sets and the optimal hyperparameters- and using machine learning model to learn the optimal hyperparameters. The method 600 may be performed by a processor executing computer program instructions within any type of computing device.

Within the method 600, the processor may collect problem data 612 and solution data 614 at step 602 to generate a library of problem solution data. At step 604, the processor may train a neural network model on the library to learn the hyperparameters that may allow for a more efficient solution convergence. Based on the training the machine learning model, the processor may determine an optimal configuration of the hyperparameters (e.g., using Bayesian optimization). The processor may store the learned optimized hyperparameters at a data processing unit 610. Therefore, when the processor receives an input of a new problem data at step 616, the processor may leverage the learned optimal hyperparameters (e.g., by deploying the trained model) to determine the optimal hyperparameters for the new problem data.

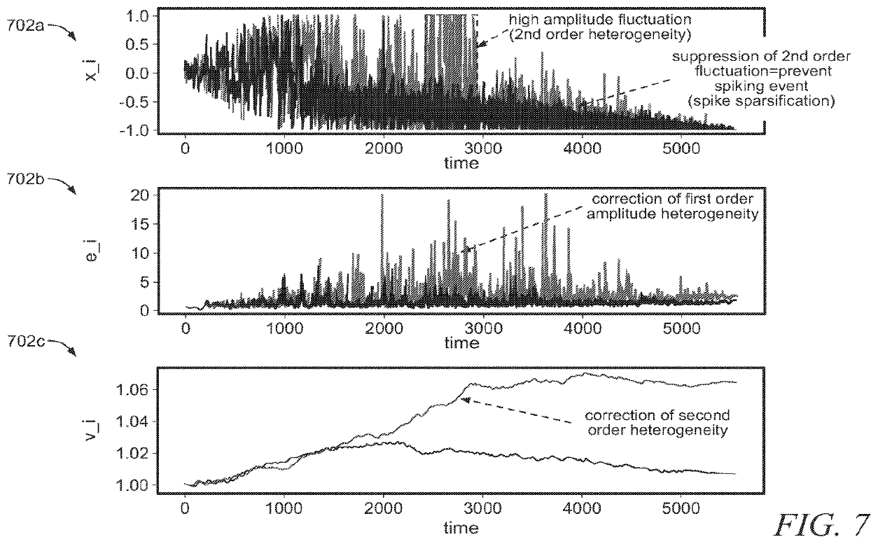

FIG. 7 shows example graphs 702a-702c illustrating a reduction of energy consumption by correcting amplitude heterogeneity, according to example embodiments of this disclosure. Particularly, the first graph shows two couplings (xi, for two different subnetworks) based on matrix vector multiplication. As shown, both of the couplings have a high amplitude fluctuation based on the amplitude heterogeneity. When the amplitude heterogeneity is suppressed (e.g., partially suppressed) using the sparsification (the bottom-up error correction as described throughout this disclosure), the amplitude fluctuation decreases. Graph 702b shows a concomitant decrement in the amplitude heterogeneity error as a result of the suppression. Graph 702c shows that the voltage (corresponding to the energy consumed) by the coupling is significantly decreased as a result of the bottom-up error correction.

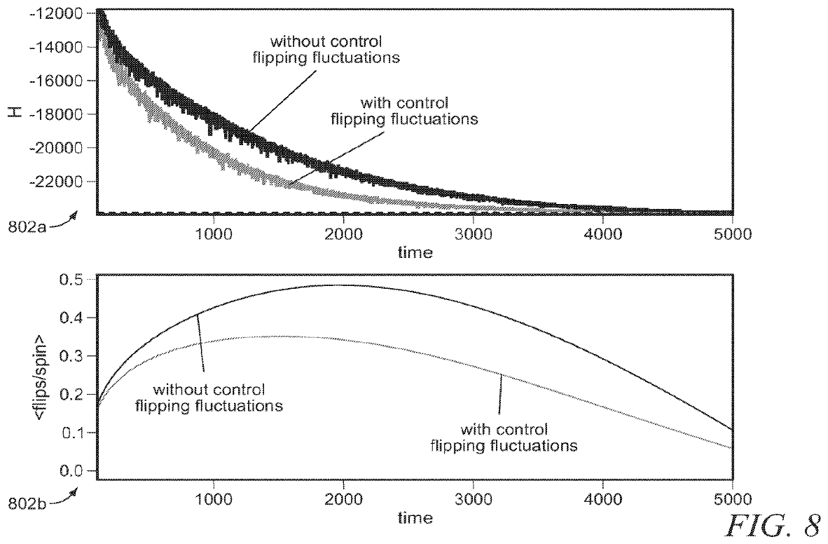

FIG. 8 shows examples graphs 802a and 802b illustrating the beneficial effects of controlling flipping fluctuations (e.g., based on bottom up error control), according to example embodiments of this disclosure. Particularly, graph 802a shows two trends of solution convergence: a first (the top trend) without controlling flipping fluctuations and a second (the bottom trend) with control of the flipping fluctuations (using the bottom-up approach described throughout this disclosure). As seen in the graph 802a, the bottom trend converges faster compared to the top trend. Graph 802b shows the tend of flips per spin for both of controlled flipping fluctuations and without controlled flipping fluctuations. As seen in the graph 802b, the top trend without the controlled flipping fluctuations has a higher amount of flips per spin compared to the bottom trend without the controlled flipping fluctuations.

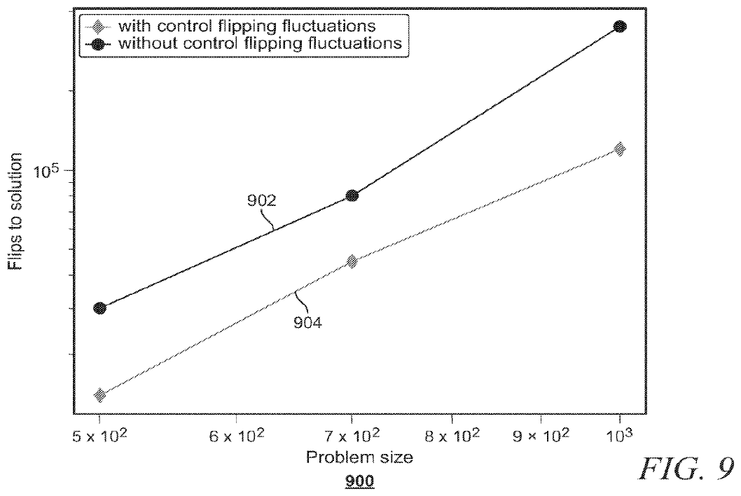

FIG. 9 shows an example graph 900 illustrating flips to solution convergence, according to example embodiments of this disclosure. The top trend 902 represents number of flips to solution without controlled flipping fluctuations. The bottom trend 904 represents the number of flips to solution with controlled flipping fluctuations. As seen in the graph 900, the number of flips to solution for controlled flipping fluctuations remains consistently lower than the number of flips to solution without controlled flipping fluctuations for different number of problem sizes.

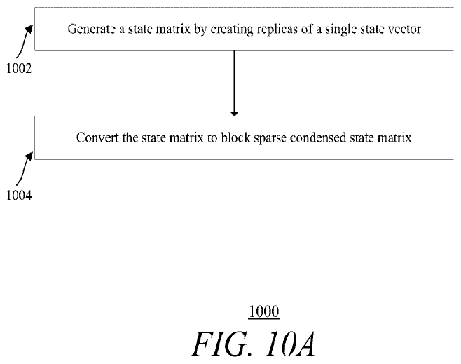

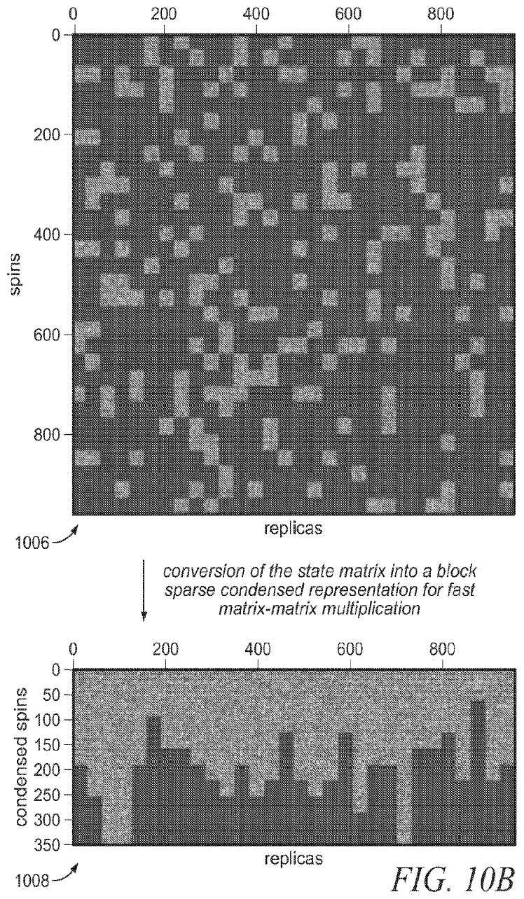

FIG. 10A shows a flow diagram of an example method 1000 for block sparsifying state vectors, according to example embodiments of this disclosure. At step 1002, a processor may generate a state matrix may by creating replicas of a single state vector, with each replica corresponding to a different starting point of the state vector. For example, FIG. 10B shows an example state matric 1006, according to example embodiments of this disclosure. As shown, a state vector (forming a single column of the state matrix) may have 1000 spins- and 999 replicas of the state vector may be created for the state matrix 1006 to have 1000 columns. Therefore, the example state matrix 1006 may have a dimension of 1000*1000. It should however be understood that this dimension is just an example, and state matrices with other dimensions are to be considered within the scope of this disclosure.

At step 1004, the processor may convert the state matrix 1006 into a block sparse condensed state matrix. FIG. 10B also shows an example block sparse condensed state matrix 1008, according to example embodiments of this disclosure. Particularly, a cluster of spins in the block sparse condensed state matrix 1008 may be represented by a single spin. In other words, as opposed to tracking and using individual level spin, block level spins (each comprising a cluster of spins) may be tracked and used. The tradeoff in accuracy due to block sparsifying may be offset by reduction in time and energy usage for solution convergence. Therefore, if a faster solution is needed—with a lower level of accuracy—block sparsification may be used.

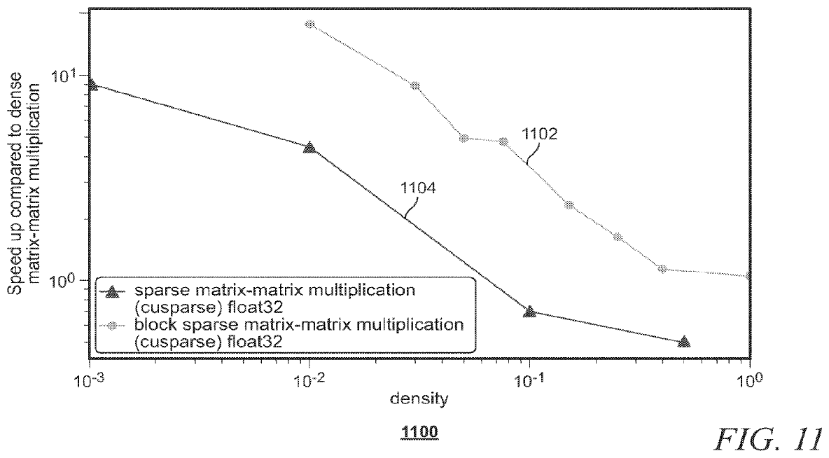

FIG. 11 shows a graph 1100 illustrating speed gain in solution convergence due to block sparsification, according to example embodiments of this disclosure. Particularly, the top trend 1102 shows a speed up for a block sparse matrix-matrix multiplication compared to dense matrix-matrix multiplication. The bottom trend 1104 shows a speed for a sparse matrix-matrix multiplication compared to dense matrix-matrix multiplication. As seen in the graph 1100, there is significant speed advantage to block sparsifying a state matrix compared to a non-block sparsifed state matrix.

FIG. 12 shows an example system 1200 illustrating graphics processing unit (GPU) based hardware implementation of example embodiments of this disclosure. In the system 1200, digital electronics 1202 provide simulation 1204, augmented by the weights (representing the problem) write controller 1216, to subnetworks implemented by matrix vector multiplication (MVM) computing units 1206. Digital electronics 1202 is further used for condensing events and weights-using condensed state encoding 1208 while providing the data (e.g., events and weights) to data input registers 1210; and using condensed state decoding 1212 to decode condensed data received from the computing units 1206 through the data output registers 1214. A cache memory 1218 may be used to store input data from the data input registers 1210 and output data to the data output registers 1214. The digital electronics (i.e., transistors) based computing units 1206 calculate the corresponding coupling through matrix vector multiplication. An off-chip memory 1220 stores the weights that cannot fit onto the on-chip memory.

FIG. 13 shows an example system 1300 illustrating field programmable gate array (FPGA) based hardware implementation of example embodiments of this disclosure. In the system 1300, digital electronics 1302 provide simulation 1304, augmented by the weights (representing the problem) write controller 1316, to subnetworks implemented by MVM computing units 1306. Digital electronics 1302 is further used for condensing events and weights—using condensed state encoding 1308 while providing the data (e.g., events and weights) to data input registers 1310; and using condensed state decoding 1312 to decode condensed data received from the computing units 1306 through the data output registers 1314. On-chip random access memory (RAM) 1318 may be used to store input data from the data input registers 1310 and output data to the data output registers 1314. The digital electronics (i.e., transistors) based computing units 1306 calculate the corresponding coupling through matrix vector multiplication. An off-chip memory 1320 stores the weights that cannot fit onto the on-chip memory.

FIG. 14 shows an example system 1400 illustrating application specific integrated circuit (ASIC) chiplet neuromorphic hardware implementation of example embodiments of this disclosure. In the system 1400 enabled by digital electronics 1402, multiple MVM computing blocks (an example shown as 1422) formed by chiplets are in parallel. Each of the MVM computing blocks may comprise multiple MVM computing units 1406. The MVM computing units 1406 calculate the matrix-vector (and/or matrix-matrix) multiplication. One or more event controllers 1424a and 1424b stream events such as events from the subnetwork simulations 1404a and 1404b. The events may be streamed using an event bus 1426. One or more weight controllers 1428a and 1428b stream weights (representing the problem) to and from the MVM computing blocks and the MVM computing units 1406 therein. On-chip RAMS (an example shown as 1418) may store the events and weights closer to MVM computing units. One or more off-chip memory modules 1420a and 1420b store weights that cannot fit onto the on-chip memory.

FIG. 15 shows an example system 1500 illustrating hybrid digital electronic hardware and non-volatile memory-based implementation of example embodiments of this disclosure. In the system 1500 enabled by an on-chip memory 1518 that is a non-volatile memory, the non-volatile memory may comprise phase-change memories, resistive memories (e.g., RRAMs), spintronics (e.g., spin transfer torque MRAM), etc. Particularly, a non-volatile memory (NVM) crossbar array 1534 performs the matrix vector multiplication. Digital electronics 1502 may provide a subnetworks simulation 1504, augmented by the weights (representing the problem) write controller 1516, to the subnetworks array implemented by the NVM crossbar array 1534. Digital electronics 1502 is further used for condensing events and weights—using condensed state encoding 1508 while providing the data (e.g., events and weights) to data input registers 1510; and using condensed state decoding 1512 to decode condensed data received from the NVM crossbar array 1534 through the data output registers 1514. On-chip memory 1518 may be used to store input data from the data input registers 1510 and output data to the data output registers 1514. The data from the digital electronics is converted to analog format using a digital analog converter (DAC) 1530 and the data from the NVM crossbar array 1534 is converted back to digital format using an analog to digital converter (ADC) 1532. An off-chip memory 1520 stores the weights that cannot fit onto the on-chip memory.

FIG. 16 shows an example system 1600 illustrating hybrid digital electronic hardware and photonics on chip implementation of example embodiments of this disclosure. Particularly, Mach-Zehnder Interferometer (MZI) 1634 performs the matrix vector multiplication in the optical domain within the hybrid system 1600. In the electronic domain, digital electronics 1602 may provide a subnetworks simulation 1604, augmented by the weights (representing the problem) write controller 1616, to the subnetworks array implemented in the optical domain. Digital electronics 1602 is further used for condensing events and weights—using condensed state encoding 1608 while providing the data (e.g., events and weights) to data input registers 1610; and using condensed state decoding 1612 to decode condensed data received from the optical domain through the data output registers 1614. The digital data in the electronic domain is converted to analog data to be used in the optical domain using a digital analog converter (DAC) 1630. On the other side, analog data from the optical domain is converted back to digital format using an analog to digital converter (ADC) 1632. On the input side of the optical domain, the analog data from the DAC 1630 may control a modulator 1638 to control the intensity of coherent light generated by a light source 1636. The controlled intensity may therefore encode the information input to MZI 1634. The result of the matrix-vector multiplication may be captured by the detector 1640 as also encoded into the received light intensities. For instance, the detector 1640 may convert the received light intensities into analog electronic signals to be fed into the ADC 1632. An off-chip memory 1620 stores the weights that cannot fit onto the on-chip memory.

FIG. 17 shows an example system 1700 illustrating hybrid digital electronic hardware and an optical domain spatial matrix-vector multiplier of example embodiments of this disclosure. Particularly, a spatial domain light modulator 1734 performs an optical matrix-vector multiplication within the hybrid system 1700. In the electronic domain, digital electronics 1702 may provide a subnetworks simulation 1704, augmented by the weights (representing the problem) write controller 1716, to the subnetworks array implemented in the optical domain. Digital electronics 1702 is further used for condensing events and weights—using condensed state encoding 1708 while providing the data (e.g., events and weights) to data input registers 1710; and using condensed state decoding 1712 to decode condensed data received from the optical domain through the data output registers 1714. The digital data in the electronic domain is converted to analog data to be used in the optical domain using a digital analog converter (DAC) 1730. On the other side, analog data from the optical domain is converted back to digital format using an analog to digital converter (ADC) 1732. On the input side of the optical domain, the analog data from the DAC 1730 may control a spatial light source 1738 to modulate, according to the input weights, incoherent light generated by a light source 1736. The fanning out the modulated incoherent light output may therefore encode the information input the spatial light modulator 1734. On the output side of the optical domain, the result of the matrix-vector multiplication in the spatial light modulator 1734 may be captured by the detector array 1740 and then provided to the DC 1732. An off-chip memory 1620 stores the weights that cannot fit onto the on-chip memory.

Embodiments disclosed herein therefore model neural sampling using winner-takes-all circuits. The model is general and can be applied to solving Ising, integer programming, satisfiability and constrained problems. There is a regime for which the information exchanged to reach optimal solution is minimal. Furthermore, the energy to solution that is order to magnitudes smaller than conventional methods. The neuro-inspired and asynchronous nature of the proposed scheme implies that the proposed scheme could result in previously unmatched reduction in energy consumption to solve optimization problems.

In the disclosed embodiments, the smallest unit of computation may be the winner takes all (WTA) circuits (e.g., as shown in FIG. 3). Because of the reciprocal connections between excitatory and inhibitory units, only a single neuron remains active after a transient period. If the state of units is analog and deterministic (mean-field approximation), the winner remains active after the transient period. If the state is discrete and deterministic, the winner remains active during an activation period on average, but random change in the winner unit can occur. For Ising models (e.g., as shown in FIG. 4), the + and − excitatory units encode for +1 and −1 spins. For integer programming problems, each unit encodes either for an integer or a representation in a certain base.

The motivation for utilizing such WTA circuits composed of very simple computing elements is that they can be implemented by a very small hardware footprint such as a few sub-threshold transistors per WTA. Moreover, such architecture is scalable to billions of WTA circuits in principle using recent lithographic processes (˜4 nm). The WTA units generate events sparsely in time. The timing of generation of an event depends on multiple factors: the internal state of the WTA unit, the external input from other WTA subnetworks, and the external input. When WTA circuits are interconnected (e.g., as shown in FIG. 4), the subnetworks sample from the Boltzmann distribution. When the context units are taken into account (e.g., as shown in FIG. 2), a trace of the states visited or sampled by the WTA circuit is stored in analog signals. Such signals include the heterogeneity in amplitude of state units for example. The context unit modulates, in turn, the state units by introducing a bias in the distribution sampled by the WTA circuits. The asymmetric top-down information creates entropy production that allows escaping from a local minimum.

The rate at which events are generated by each unit is controlled by the bottom-up units. The input units receive information from the events communication between subnetworks and can modulate the number of events of each unit. The mechanism for the bottom-up “attention” signal that controls the flipping rate is detailed in FIGS. 7-9. FIG. 7 shows the times series of the system solving a N=1000 Sherrington-Kirkpatrick problem where the bottom-up signal can detect spins that exhibit higher amplitude fluctuation. This error signal is used to reduce flipping rate which results in less number of flips while accelerating the decrease of Ising energy with time (e.g., as shown in FIG. 8). FIG. 9 shows that the reduction of flipping rate scales well with problem size $N$. The control of flipping rate acts as a control of entropy production. The correction of amplitude heterogeneity (top-down signals) results in an increase of entropy production for escaping from the local minimum of the energy landscape. When the entropy production is too high at some time step during the computation, many spins are flipped with increased randomness as the entropy production is high. By preventing entropy production from becoming too large, the bottom-up inputs create a control of chaos for faster convergence to the lower energy states in addition to increasing sparsity of communication. Overall, energy to solution is reduced by this mechanism. It should be also noted that bottom-up signals control the fluctuation of flipping rate which results in a reduction of the heterogeneity in the variance of amplitudes.

The top-down and bottom-up inputs to the state unit differ in their modulating action. Top-down units modulate the variable representing the difference between analog states, whereas input units modulate their sum. By doing so, top-down input modulates the transition between configurations of the combinatorial problem, whereas bottom-up input modulates the timing and amount of events exchanged between WTAs. Importantly, the modulation of WTA input allows reducing the number of events per step of the computation, i.e., increasing the sparsity of events in time without changing the dynamics of the system within a certain range of parameters. Thus, the data processing unit (also referred to as computation unit) can be controlled to generate events that are sparse in time and, consequently, the computational cost of coupling WTAs between time steps is greatly reduced which results, in turn, in significant speed up and reduction of energy consumption.

The reduction of flipping rate, while being suited to neuromorphic hardware, can also be applied to an implementation on conventional digital electronics such as GPUs and FPGAs. In the case of GPUs, the spin flip matrix is sparsified by blocks for greater reduction of computational time using block sparse matrix-matrix multiplications (e.g., as shown in FIGS. 10A-11) with a >1Ox decrease of computational time in the case of 1% density compared to dense matrix-matrix multiplications.

Additional examples of the presently described method and device embodiments are suggested according to the structures and techniques described herein. Other non-limiting examples may be configured to operate separately or can be combined in any permutation or combination with any one or more of the other examples provided above or throughout the present disclosure.

It will be appreciated by those skilled in the art that the present disclosure can be embodied in other specific forms without departing from the spirit or essential characteristics thereof. The presently disclosed embodiments are therefore considered in all respects to be illustrative and not restricted. The scope of the disclosure is indicated by the appended claims rather than the foregoing description and all changes that come within the meaning and range and equivalence thereof are intended to be embraced therein.

It should be noted that the terms “including” and “comprising” should be interpreted as meaning “including, but not limited to”. If not already set forth explicitly in the claims, the term “a” should be interpreted as “at least one” and “the”, “said”, etc. should be interpreted as “the at least one”, “said at least one”, etc. Furthermore, it is the Applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed is:

1. An optimization method implemented by a computational subnetwork, the method comprising:
initializing, by a state node of the computational subnetwork, a state vector;
injecting, by a context node of the computational subnetwork, amplitude heterogeneity errors to the state vector, the injecting avoiding a solution converging on a local minimum point; and
selectively controlling, by an input node of the computational subnetwork, the amplitude heterogeneity error by fixing states of high error states for durations of corresponding refractory periods.

2. The method of claim 1, wherein the durations of refractory periods are proportional to signal that detects the contribution of a spin flip to the dynamics of global convergence comprising at least one of variance introduced to the states by corresponding heterogeneity errors, the amplitude of the internal field, or the amplitude of the error in amplitude heterogeneity.

3. The method of claim 1, wherein the state vector represents binary states.

4. The method of claim 1, wherein the state vector represents multi-level variable states.

5. The method of claim 1, further comprising:
avoiding memory access of weights corresponding to the fixed states.

6. The method of claim 1, wherein each state of the state vector is represented by a winner takes all neuromorphic circuit.

7. A system comprising:
a plurality of computational subnetworks, configured to perform an optimization method, each computational subnetwork comprising:
a state node configured to store a state element of a current state vector;
a context node configured to introduce an amplitude heterogeneity error to the state element stored in the state node; and
an input node configured to control the amplitude heterogeneity error of the state element by fixing the state of the state element for a corresponding refractory period.

8. The system of claim 7, wherein a duration of the refractory period is proportional to signal that detects the contribution of a spin flip to the dynamics of global convergence comprising at least one of a variance introduced to the state element by the amplitude heterogeneity error, a amplitude of the internal field, or the amplitude of the error in amplitude heterogeneity.

9. The system of claim 7, wherein the state element comprises a binary variable.

10. The system of claim 7, wherein the state element comprises a multi-level variable.

11. The system of claim 7, further comprising:
an event controller configured to provide an event input, indicating a change in state of another state node, to the state node.

12. The system of claim 7, further comprising:
a weight controller configured to provide a weight to the state node.

13. The system of claim 12, wherein the weight controller is configured to avoid retrieving the weight from memory during the corresponding refractory period.

14. The system of claim 7, wherein the state node comprises a winner takes all neuromorphic circuit with multiple sub-nodes.

15. The system of claim 14, wherein the multiple sub-nodes comprise one or more excitatory nodes and one or more inhibitory nodes.

16. The system of claim 14, wherein the winner takes all neuromorphic circuit comprises one or more excitatory connections and one or more inhibitory connections.

17. The system of claim 7, wherein the plurality of computational subnetworks is implemented using an electronic circuit.

18. The system of claim 17, wherein the electronic circuit comprises at least one of a graphical processing unit (GPU), a field programmable gate array (FPGA), an application specific integrated circuit (ASIC) chiplet, and a hybrid digital circuit.

19. The system of claim 7, wherein the plurality of computational subnetworks is implemented using an optical circuit.

20. The system of claim 19, wherein the optical circuit comprises at least one of a Mach-Zehnder Interferometer or a spatial light modulator.
